(19) United States
(12) Patent Application Publication
(10) Pub. No.: US 2005/0139261 A1
(43) Pub. Date: Jun. 30, 2005

(54) Valve

(76) Inventor: Benoit Bahl, Goetzenbruck (FR)

Correspondence Address: Richard A Speer;Mayer Brown Rowe & Maw, 190 South La Salle Street, Chicago, IL, 60603-3441, US

(21) Appl. No.: 10/508,301

(22) PCT Filed: Mar. 17, 2003
(86) PCT No.: PCT/DE03/00856

(30) Foreign Application Priority Data
Mar. 22, 2002 (DE) 102 12 952.5
Oct. 31, 2002 (DE) 102 50 923.9

(51) Int. Cl. F16K 17/36

(52) U.S. Cl. 137/43

(57) ABSTRACT

The invention relates to a valve (11), embodied as a rollover valve for arrangement in a fuel supply line of a motor vehicle, with a valve body (14) having a conical section (16) and a tubular section (17) connected thereto. The valve body (14) has a thin wall section in comparison to the diameter thereof. The valve (11) is thus particularly economical to produce.

The invention relates to a valve which is envisaged for arrangement in a fuel-conducting pipe of a motor vehicle, having a valve body and having a valve seat, in which the valve body is held at a distance from the valve seat at least when the fuel flows through the pipe.

In motor vehicles nowadays, valves of this type are frequently referred to as “rollover valves” and are known from practice. These valves have the task of, in the event of the motor vehicle crashing or overturning, preventing fuel from running out after the fuel-conducting pipe has been torn off. The force which keeps the valve body at a distance from the valve seat can thus, for example, be the force of gravity, a spring force or a rubber-elastic element. The valve body is designed, for example, as a ball or as a duckbill valve. The disadvantage with the known valve is that it is very complex to manufacture.

The invention is based on the problem of developing a valve of the type mentioned at the beginning in such a manner that it can be manufactured as simply as possible and reliably prevents fuel from running out if the fuel-conducting pipe has been torn off.

This problem is solved according to the invention by the valve body having a conical section opposite the valve seat and a small wall thickness in relation to its diameter.

This design enables the valve body to have a particularly low weight and enables it to be manufactured particularly cost-effectively. The valve body is preferably manufactured from plastic by injection molding. The conical design of the valve body enables it to be reliably picked up by a flow counter to the flow direction during normal operation and to be pressed against the valve seat, if the fuel-conducting pipe has been torn off. Fuel is thus reliably prevented from running out. In normal operation, the flow presses the valve body away from the valve seat. In this case, the flow is not constricted by the conical design of the valve body.

The manufacturing costs of the valve according to the invention are further reduced if the valve seat is arranged on a flange closing an installation opening of the fuel tank.

A discharge of fuel through sealing points of the valve according to the invention into the environment can be reliably avoided if a guide for the valve body is arranged in a guide sleeve connected to the flange, and if, when the flange is fitted, the guide sleeve protrudes into the fuel tank.

The installation of the valve according to the invention turns out to be particularly cost-effective if the guide sleeve is connected at its end projecting away from the flange to a connecting pipe. Since the connecting pipe is provided in any case for a pipe guided, for example, within the fuel tank, the structural outlay incurred by the arrangement by the valve according to the invention is also kept particularly low.

The reliable carrying-along of the valve body by a heavy flow in the valve according to the invention can be achieved in a simple manner with little structural outlay if a tubular section adjoins the conical section of the valve body and if the tubular section has a smaller diameter than the guide.

According to another advantageous development of the invention, the valve body is guided reliably in the guide against the valve seat if a radially outwardly pointing collar adjoins the tubular section.

According to another advantageous development of the invention, the resistance offered by the valve body to the fuel flow can be brought about in a simple manner if recesses provided for fuel to flow through are arranged in the tubular section and/or the collar.

A malfunction of the valve according to the invention can be avoided in a simple manner if the connecting pipe holds the valve body in its position spaced apart from the valve seat. The securing of the valve body on the connecting pipe can take place in a form-fitting or frictional manner or can be produced by means of a predetermined breaking point.

The manufacturing costs of the valve according to the invention are further reduced if the valve seat is manufactured as a single piece together with the flange.

The valve according to the invention turns out to be particularly simple structurally if the guide sleeve and the connecting pipe are designed as a single-piece component which is connected to the flange.

The invention permits numerous embodiments. To further clarify its basic principle one of these is illustrated in the drawing and will be described below. In the drawing

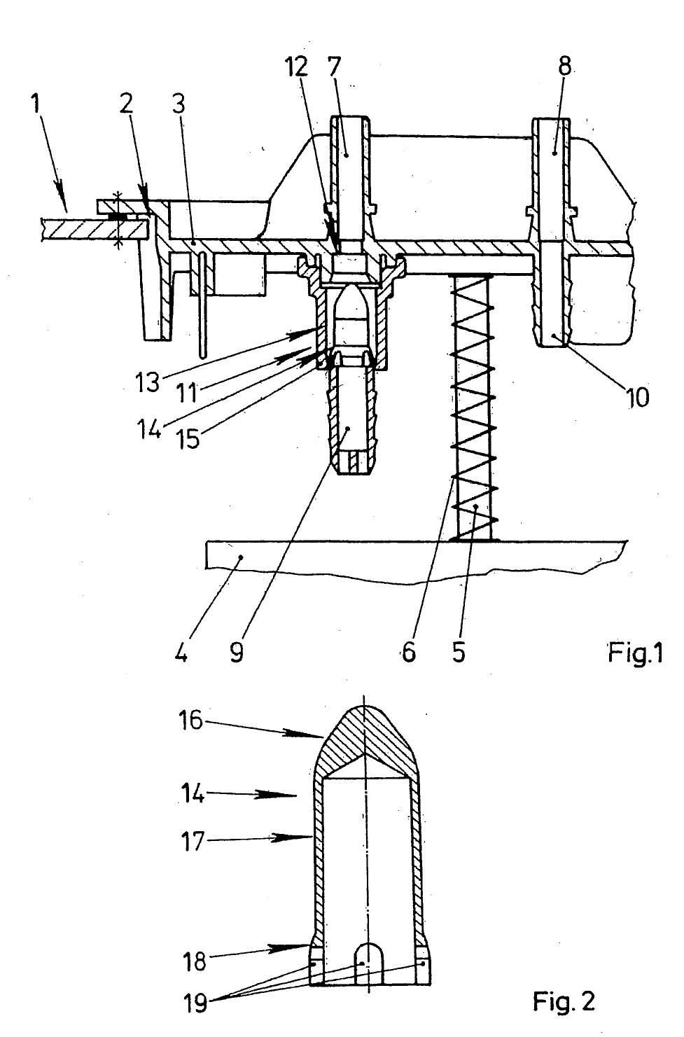

FIG. 1 shows a subregion of a fuel tank with a valve according to the invention,

FIG. 2 shows a greatly enlarged illustration of a valve body of the valve according to the invention from FIG. 1.

FIG. 1 shows a sectional illustration through a subregion of a fuel tank 1 having a flange 3, which is inserted in an installation opening 2, and having a baffle 4 for accommodating a fuel feed pump (not illustrated). The baffle 4 is guided relative to the flange 3 by means of a guiding pipe 5 and is prestressed against the bottom of the fuel tank 1 by a spring element 6. The flange 3 has two connecting pipes 7-10 in each case on its end sides. The connecting pipes 7-10 are used for the connection of a forward flow line and a return flow line. A valve 11 is arranged in one of the connecting pipes 9, which is arranged on the side pointing toward the interior of the fuel tank 1. The valve 11 has a valve seat 12, which is manufactured as a single piece together with the flange 3, and a valve body 14, which is arranged in a guide 13. The guide 13 is arranged in a guide sleeve 15, which is manufactured as a single piece together with the connecting pipe 9. The valve body 14 is held in its position spaced apart from the valve seat 12 by the connecting pipe 9.

FIG. 2 shows the valve body 14 in a greatly enlarged sectional illustration. The valve body 14 has a conical section 16 and a tubular section 17 adjoining it. That end of the tubular section 17 which faces away from the conical section 16 bears a radially projecting collar 18 having recesses 19 for the fuel to flow through. The collar 18 has an outside diameter approximately corresponding to the dimensions of the guide 13.

1. A valve which is envisaged for arrangement in a fuel-conducting pipe of a motor vehicle, having a valve body and having a valve seat, in which the valve body is held at a distance from the valve seat at least when fuel flows through the pipe, characterized in that the valve body (14) has a conical section (16) opposite the valve seat (12) and a small wall thickness in relation to its diameter.

2. The valve as claimed in claim 1, characterized in that the valve seat (12) is arranged on a flange (3) closing an installation opening (2) of the fuel tank (1).

3. The valve as claimed in claim 1 or 2, characterized in that a guide (13) for the valve body (14) is arranged in a guide sleeve (15) connected to the flange (3), and in that when the flange (3) is fitted, the guide sleeve (15) protrudes into the fuel tank (1).

4. The valve as claimed in at least one of the preceding claims, characterized in that the guide sleeve (15) is connected at its end projecting away from the flange (3) to a connecting pipe (9).

5. The valve as claimed in at least one of the preceding claims, characterized in that a tubular section (17) adjoins the conical section (16) of the valve body (14), and in that the tubular section (17) has a smaller diameter than the guide (13).

6. The valve as claimed in at least one of the preceding claims, characterized in that a radially outwardly pointing collar (18) adjoins the tubular section (17).

7. The valve as claimed in at least one of the preceding claims, characterized in that recesses (19) provided for fuel to flow through are arranged in the tubular section (17) and/or the collar (18).

8. The valve as claimed in at least one of the preceding claims, characterized in that the connecting pipe (9) keeps the valve body (14) in its position spaced apart from the valve seat (12).

9. The valve as claimed in at least one of the preceding claims, characterized in that the valve seat (12) is manufactured as a single piece together with the flange (3).

10. The valve as claimed in at least one of the preceding claims, characterized in that the guide sleeve (15) and the connecting pipe (9) are designed as a single-piece component which is connected to the flange (3).
